(19) United States
(12) Patent Application Publication
(10) Pub. No.: US 2025/0293367 A1
(43) Pub. Date: Sep. 18, 2025

(54) BATTERY PACK AND ELECTRIC VEHICLE

(71) Applicant: YAMAHA HATSUDOKI KABUSHIKI KAISHA, Iwata-shi (JP)

(72) Inventors: Noriyuki ENAMI, Shizuoka (JP); Daiki ITO, Shizuoka (JP)

(21) Appl. No.: 19/223,801

(22) Filed: May 30, 2025

Related U.S. Application Data
(63) Continuation of application No. PCT/JP2023/038788, filed on Oct. 26, 2023.

(30) Foreign Application Priority Data
Dec. 1, 2022 (JP) 2022-193147

(51) Int. Cl. H01M 50/24; B62J 43/16; B62K 11/02; H01M 10/613; H01M 10/625; H01M 10/6551; H01M 50/204; H01M 50/249; H01M 50/262; H01M 50/298; H01M 50/502

(52) U.S. Cl. CPC H01M 50/24; B62J 43/16; B62K 11/02; H01M 10/613; H01M 10/625; H01M 10/6551; H01M 50/204; H01M 50/249; H01M 50/262; H01M 50/298; H01M 50/502; H01M 2220/20

(57) ABSTRACT

An electric two-wheeled vehicle includes a battery pack supported by a body frame. The battery pack includes a first case including a first case main body including walls having an H-shaped cross section defined by an enclosed portion including two open ends and a partition dividing an inside of the enclosed portion into a first storage and a second storage, a first flange at an outer circumference of a first end of the first case main body, and a second flange at an outer circumference of a second end of the first case main body. A first plate is fixed to the first flange to close the first storage, and a second plate is fixed to the second flange to close the second storage. A first battery assembly is housed in the first storage and a second battery assembly is housed in the second storage.

### CROSS REFERENCE TO RELATED APPLICATIONS

This application claims the benefit of priority to Japanese Patent Application No. 2022-193147 filed on Dec. 1, 2022 and is a Continuation Application of PCT Application No. PCT/JP2023/038788 filed on Oct. 26, 2023. The entire contents of each application are hereby incorporated herein by reference.

### BACKGROUND OF THE INVENTION

### 1. Field of the Invention

The present invention relates to battery packs and electric vehicles, and more specifically to battery packs in which a plurality of battery assemblies are stacked in tiers, and to electric vehicles using the same, including, for example, electric two-wheeled vehicles.

### 2. Description of the Related Art

As an example which is pertinent to conventional techniques of this kind, Japanese Patent No. 5571713 discloses an electric energy storage device for an automobile. The electric energy storage device includes a housing and a storage module housed in the housing. The housing includes a supporting element, a housing upper portion, and a housing lower portion. The supporting element includes an annular supporting frame made of a fiber-reinforced plastic, and a supporting plate made of a metal. The annular supporting frame sandwiches the supporting plate from above and below thus being attached to the supporting plate, and by using the annular supporting frame, it is possible to connect the electric energy storage device with a main body structure of the automobile. The annular supporting frame is formed to absorb all forces and moments acting on the electric energy storage device, while all other members constituting the housing than the annular supporting frame are formed as non-load bearing cover-type parts which do not absorb any forces or moments. Also, sealing elements are positioned respectively between the housing upper portion and the annular supporting frame, and between the housing lower portion and the annular supporting frame.

In the electric energy storage device disclosed in Japanese Patent No. 5571713, the annular supporting frame is made of a fiber-reinforced plastic, and further, the annular supporting frame is connected with the supporting plate by simply sandwiching the supporting plate from above and below so that it would be possible to absorb all the forces and moments which act on the electric energy storage device by means of the annular supporting frame. However, there is no disclosure on increasing stiffness of the supporting element including the annular supporting frame and the supporting plate. Also, the annular supporting frame and the supporting plate are separate members made of different materials from each other. Further, the invention requires a separate sealing element in order to be water tight, i.e., the invention requires an increased number of parts.

### SUMMARY OF THE INVENTION

Therefore, example embodiments of the present invention provide battery packs each able to be water tight and have high stiffness while reducing an increase in the number of parts, and provide electric vehicles including the same.

According to an example embodiment of the present invention, a battery pack includes a first case including a first case main body including walls having an H-shaped cross section defined by an enclosed portion including two open ends and a partition dividing an inside of the enclosed portion in an axial direction into a first storage and a second storage, a first flange at an outer circumference of a first end of the first case main body, and a second flange at an outer circumference of a second end, which is an axially opposite end facing away from the first end, of the first case main body, a first plate fixed to the first flange to close the first storage, a second plate fixed to the second flange to close the second storage, a first battery assembly housed in the first storage, and a second battery assembly housed in the second storage.

In an example embodiment of the present invention, it is possible to increase stiffness of the first case while reducing an increase in the number of parts since the first case main body includes the integral walls having an H-shaped cross section. Also, it is possible to easily fix the first plate to the first flange on the outer circumference of the first end of the first case main body, and it is possible to make the first storage be water tight by closing the first storage. Likewise, it is possible to easily fix the second plate to the second flange on the outer circumference of the second end of the first case main body, and it is possible to make the second storage water tight by closing the second storage.

Preferably, the battery pack further includes a first fin provided on an outer circumferential surface of the first case main body. In this case, by providing the first fin on the outer circumferential surface of the first case main body, it is possible to increase a heat dissipation area and improve cooling performance. Also, it is possible for the first case to be light-weight and have high stiffness.

Further preferably, the battery pack further includes a second fin provided on a main surface of the partition. In this case, by providing the second fin on the main surface of the partition, it is possible to increase a heat dissipation area and improve cooling performance. Also, it is possible for the first case to be light-weight and have high stiffness.

Further, preferably, the battery pack further includes a third fin provided on a main surface of the first plate. In this case, by providing the third fin on the main surface of the first plate, it is possible to increase a heat dissipation area and improve cooling performance. Also, it is possible for the first plate to be light-weight and have high stiffness.

Preferably, the battery pack further includes a fourth fin provided on a main surface of the second plate. In this case, by providing the fourth fin on the main surface of the second plate, it is possible to increase a heat dissipation area and improve cooling performance. Also, it is possible for the second plate to be light-weight and have high stiffness.

Further preferably, the battery pack further includes a first bus bar connecting the first battery assembly and the second battery assembly with each other. With this arrangement, the partition includes a first through-hole as a passage for the first bus bar. In this case, with the first bus bar which is routed through the first through-hole of the partition, it is possible to easily connect the first battery assembly housed in the first storage with the second battery assembly housed in the second storage.

Further, preferably, the battery pack further includes a second case including a second case main body including an open end, and a third flange on an outer circumference of the open end of the second case main body. With this arrangement, the first flange and the third flange are integrally attached to each other, with the first plate sandwiched therebetween. In this case, by fastening the first flange and the third flange to each other with the first plate sandwiched therebetween, it is possible to connect the first case and the second case with each other by a flange, making it possible to make the first storage of the first case and the second case water tight. By housing the battery assemblies not only inside the first case but also inside the second case, it is possible to house a large number of batteries inside the battery pack. By housing electric components inside the second case, it is possible for the battery packs to be compact. For example, in a case where the battery pack is arranged vertically in an electric two-wheeled vehicle, with the first case located at a higher position and the second case located at a lower position, the outward bulging first and third flanges are located at a higher position than the bottom portion of the battery pack. In other words, it is possible to position the first flange and the third flange as closely to the center as possible in the up-down direction. Therefore, it is easy to bank the electric two-wheeled vehicle when turning. It also is possible to enable the knees of the rider to grip the vehicle without sacrificing a riding posture.

Preferably, the battery pack further includes a third battery assembly housed in the second case main body and a second bus bar connecting the first battery assembly and the third battery assembly with each other. With this arrangement, the first plate includes a second through-hole as a passage for the second bus bar. In this case, with the second bus bar which is routed through the second through-hole of the first plate, it is possible to easily connect the first battery assembly housed in the first storage of the first case with the third battery assembly housed in the second case.

Further preferably, the battery pack further includes a fifth fin provided on a main surface of the second case main body. In this case, by providing the fifth fin on the main surface of the second case main body, it is possible to increase a heat dissipation area and improve cooling performance. Also, it is possible for the second case to be light-weight and have high stiffness.

Further, preferably, the battery pack further includes a third case including a third case main body including an open end, and a fourth flange on an outer circumference of the open end of the third case main body. With this arrangement, the second flange and the fourth flange are integrally attached to each other, with the second plate sandwiched therebetween. In this case, by attaching the second flange and the fourth flange integrally to each other with the second plate sandwiched therebetween, it is possible to connect the first case and the third case with each other by a flange, making it possible to easily make the second storage of the first case and the third case water tight. By housing the battery assemblies not only inside the first case but also inside the third case, it is possible to house a large number of batteries inside the battery pack. By housing electric components inside the third case, it is possible to provide a compact arrangement around the battery pack. For example, in a case where the battery pack is arranged vertically in an electric two-wheeled vehicle, with the third case located at a higher position and the first case located at a lower position, the outward bulging second and fourth flanges are located at a lower position than the top portion of the battery pack. In other words, it is possible to position the second flange and the fourth flange as closely to the center as possible in the up-down direction. Therefore, it is possible to house the battery pack easily inside the body frame, and therefore also inside a cowling, of the electric two-wheeled vehicle. Further, in a case where the battery pack, in which the first case is sandwiched by the second case and the third case, is vertically arranged in an electric two-wheeled vehicle, with the third case, the first case, and the second case positioned in this order from top toward bottom, the first flange and the third flange are located at a higher position than the bottom portion of the battery pack, and the second flange and the fourth flange are located at a lower position than the top portion of the battery pack. In this case, it is possible to concentrate the flanges to an intermediate region in the vertical direction of the battery pack, so that the battery pack has a generally egg-shaped section, making it possible to provide a two-wheeled vehicle with a large volume in its center.

Preferably, the battery pack further includes a fourth battery assembly housed in the third case main body, and a third bus bar connecting the second battery assembly and the fourth battery assembly with each other. With this arrangement, the second plate includes a third through-hole as a passage for the third bus bar. In this case, with the third bus bar which is routed through the third through-hole of the second plate, it is possible to easily connect the second battery assembly housed in the second storage of the first case with the fourth battery assembly housed in the third case.

Further preferably, the battery pack further includes an electric component provided at least at one of a higher position or a lower position than the first case. In this case, it is possible to position the electric component inside or near the battery pack, and to make the electric wires inside or around the battery pack short.

Further, preferably, the battery pack further includes an electric wire connected with the electric component. With this arrangement, the partition includes a fourth through-hole as a passage for the electric wire. In this case, by having the electric wire which leads to the electric component be routed through the fourth through-hole of the partition, it is easy to lay out the wire.

Preferably, the battery pack further includes an electric wire connected with the electric component. With this arrangement, the first plate includes a fifth through-hole as a passage for the electric wire. In this case, by having the electric wire which leads to the electric component be routed through the fifth through-hole of the first plate, it is easy to lay out the wire.

Further preferably, the battery pack further includes an electric wire connected with the electric component. With this arrangement, the second plate includes a sixth through-hole as a passage for the electric wire. In this case, by having the electric wire which leads to the electric component be routed through the sixth through-hole of the second plate, it is easy to lay out the wire.

According to another example embodiment of the present invention, an electric vehicle includes the above-described battery pack and a body frame supporting the battery pack.

The battery packs described above are suitably applicable to electric vehicles. In particular, since it is possible to increase the stiffness of the first case of the battery pack, it is possible to make the first case itself as a portion of the body frame of the electric vehicle.

According to example embodiments of the present invention, battery packs are each able to be water tight and have high stiffness while reducing an increase in the number of parts, and electric vehicles including such battery packs are also provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a side view which shows an electric two-wheeled vehicle according to an example embodiment of the present invention.

FIG. 2 is a side view which shows an internal structure of the electric two-wheeled vehicle in FIG. 1.

FIG. 3 is a sectional view taken along a line A-A in FIG. 1.

FIG. 4 is a perspective view which shows a battery pack according to an example embodiment of the present invention.

FIG. 5 is a side view which shows the battery pack in FIG. 4.

FIG. 6 is a front view which shows the battery pack in FIG. 4.

FIG. 7 is a rear view which shows the battery pack in

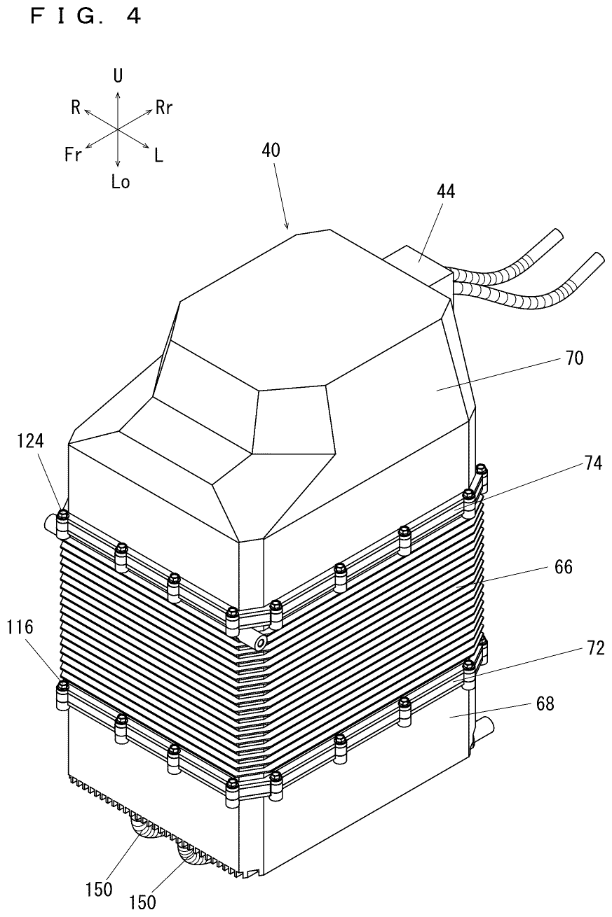

FIG. 4.

FIG. 8 is a perspective view which shows a first case.

FIG. 9 is a plan view which shows the first case.

FIG. 10 is a bottom view which shows the first case.

FIG. 11 is a perspective view which shows a first plate (a second plate).

FIG. 12 is a plan view which shows the first plate (the second plate).

FIG. 13 is a bottom view which shows the first plate (the second plate).

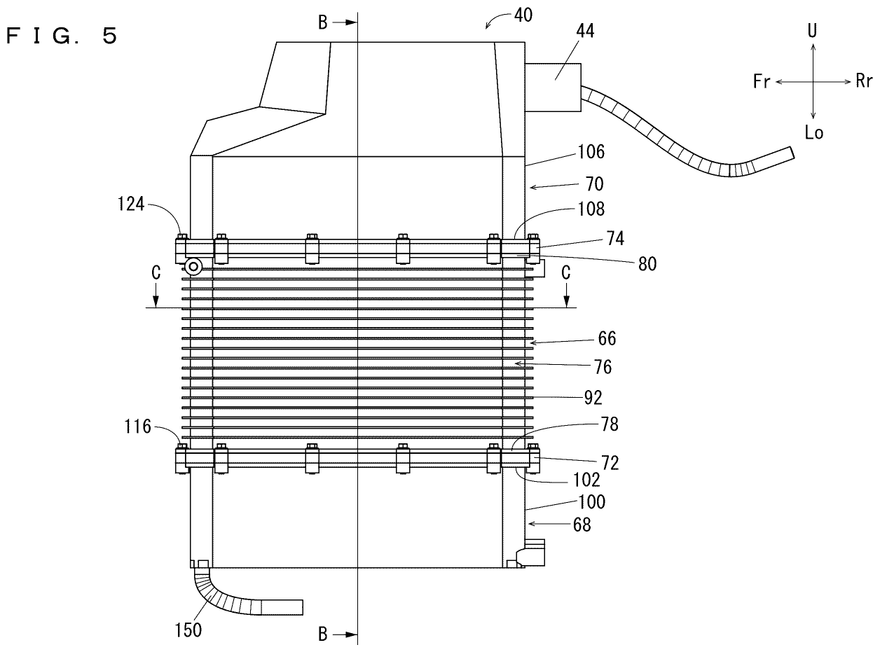

FIG. 14 is a sectional view taken along a line B-B in FIG. 5.

FIG. 15 is a sectional view taken along a line C-C in FIG. 5.

FIG. 16 is a front perspective view which shows an internal structure of the battery pack.

FIG. 17 is a rear perspective view which shows the internal structure of the battery pack.

### DETAILED DESCRIPTION OF THE EXAMPLE EMBODIMENTS

Hereinafter, example embodiments of the present invention will be described with reference to the drawings.

The terms left and right, front and rear, and up and down used in the example embodiments of the present invention refer to left and right, front and rear, and up and down based on the state where a rider of an electric two-wheeled vehicle 10 is seated in a seat 62, facing a handlebar 22. In the drawings, “Fr” indicates forward, “Rr” indicates rearward, “R” indicates rightward, “L” indicates leftward, “U” indicates upward and “Lo” indicates downward.

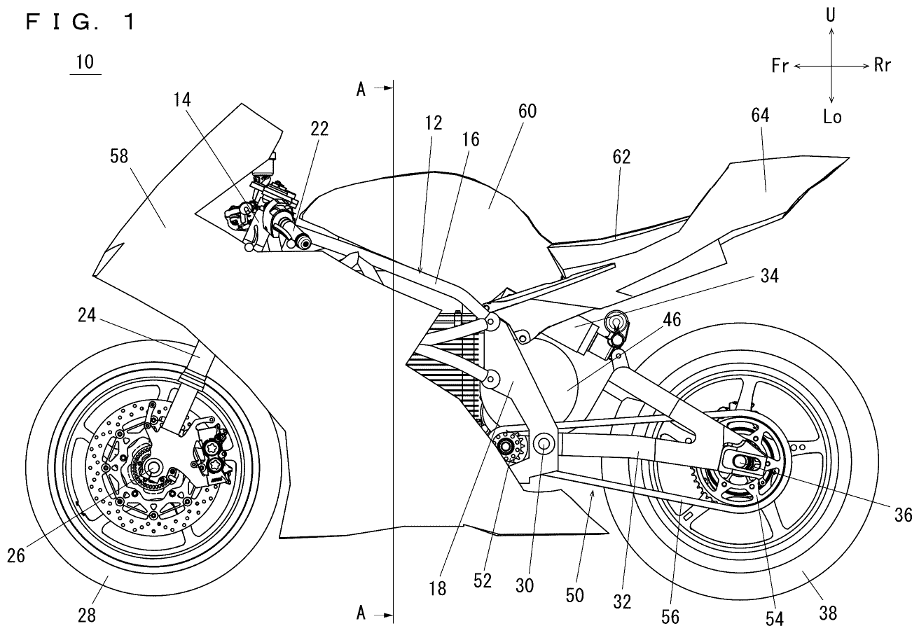

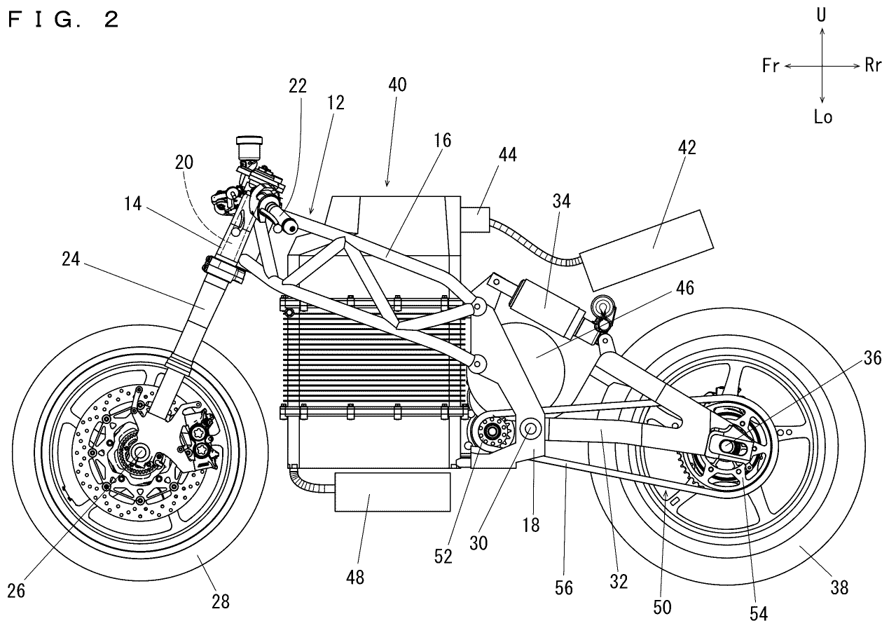

Referring to FIG. 1 and FIG. 2, the electric two-wheeled vehicle 10 according to an example embodiment of the present invention includes a body frame 12. The body frame 12 includes a head pipe 14, a front frame 16 extending obliquely rearward and downward from the head pipe 14, and a rear frame 18 connected with a rear portion of the front frame 16 and extending obliquely rearward and downward.

A steering shaft 20 is inserted into the head pipe 14 pivotably therein. The steering shaft 20 includes an upper end portion to which a handlebar 22 is attached. The steering shaft 20 includes a lower end portion to which a front fork 24 is attached. The front fork 24 includes a lower end portion to which a front wheel 28 is attached rotatably via an axle 26.

The rear frame 18 includes a lower portion to which a front end portion of a swing arm 32 is installed via a pivot axis 30, i.e., the swing arm 32 is pivotable. A suspension 34 joints a connecting point between the front frame 16 and the rear frame 18 to the swing arm 32. The swing arm 32 includes a rear end portion at which a rear wheel 38 is supported rotatably via an axle 36.

A battery pack 40 is disposed at a position overlapping the front frame 16 in a side view. The front frame 16 is substantially U-shaped in a plan view, and the battery pack 40 is disposed between two side-portions of the front frame 16. In a side view, a rear end of the battery pack 40 is located at a more forward position than the swing arm 32, and an upper end of the battery pack 40 is located at a higher position than ends of the handlebar 22 in terms of the vehicle's width. The battery pack 40 is supported by the body frame 12. Behind the battery pack 40, there is disposed an electric charger 42 to charge the battery pack 40. The electric charger 42 is connected with the battery pack 40 via a connector 44. Behind the battery pack 40, at a position overlapping the rear frame 18 in a side view, an electric motor 46 is disposed. Below the battery pack 40, there is disposed an inverter 48 which converts DC power from the battery pack 40 into AC power to supply to the electric motor 46. A driving force from the electric motor 46 is transmitted to the axle 36 via a power transfer mechanism 50 to drive the rear wheel 38 to rotate. The power transfer mechanism 50 includes a sprocket 52 close to the electric motor 46, a sprocket 54 close to the rear wheel 38, and a chain 56 connecting the sprockets 52, 54 with each other.

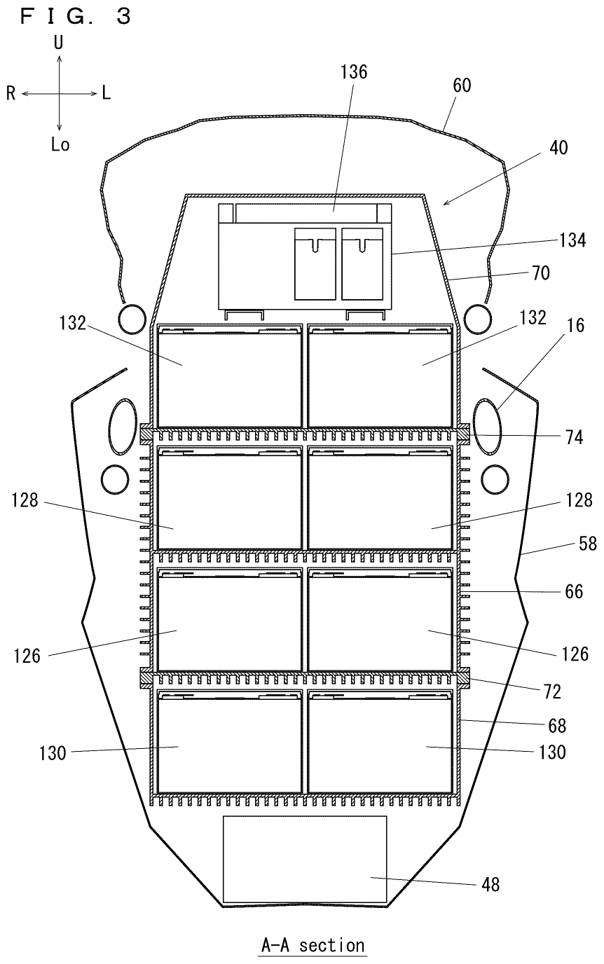

Referring further to FIG. 3, a front cowl 58 covers the head pipe 14, the front frame 16, and front and side portions of the battery pack 40. A battery cover 60 covers above the battery pack 40. A seat 62 is provided above the electric charger 42. A tale cowl 64 is provided behind the seat 62. Therefore, when traveling on the electric two-wheeled vehicle 10, the rider takes a riding posture like hugging the battery pack 40.

Hereinafter, the battery pack 40 will be described in detail.

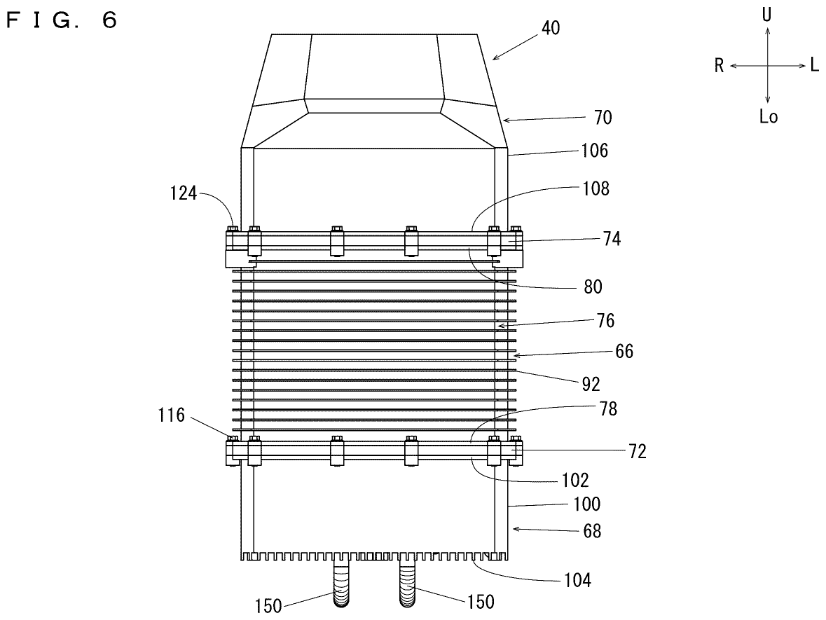

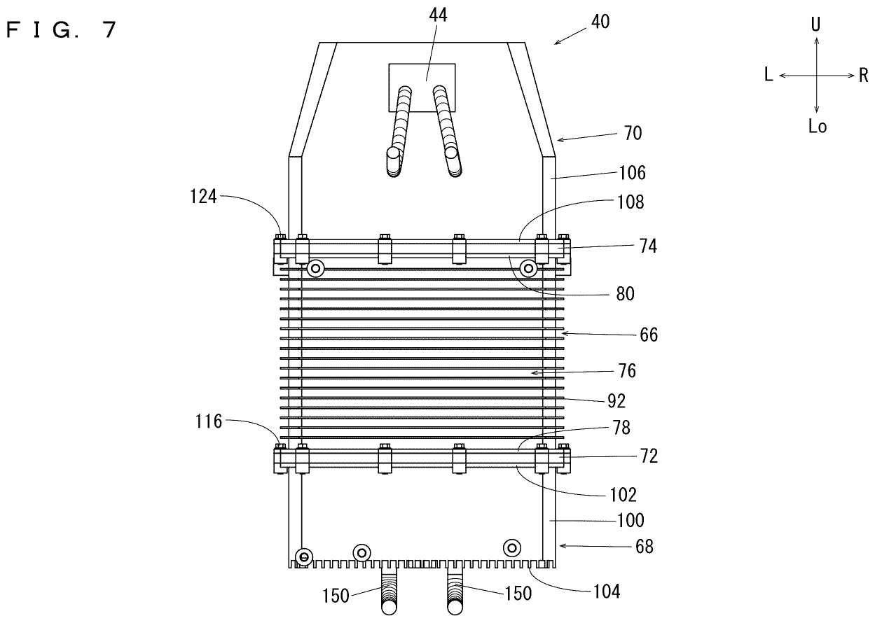

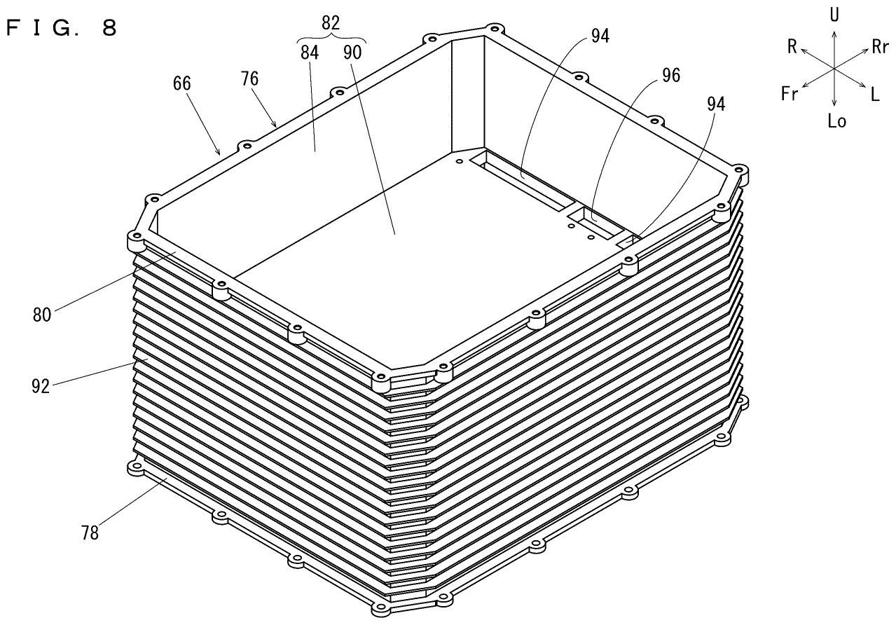

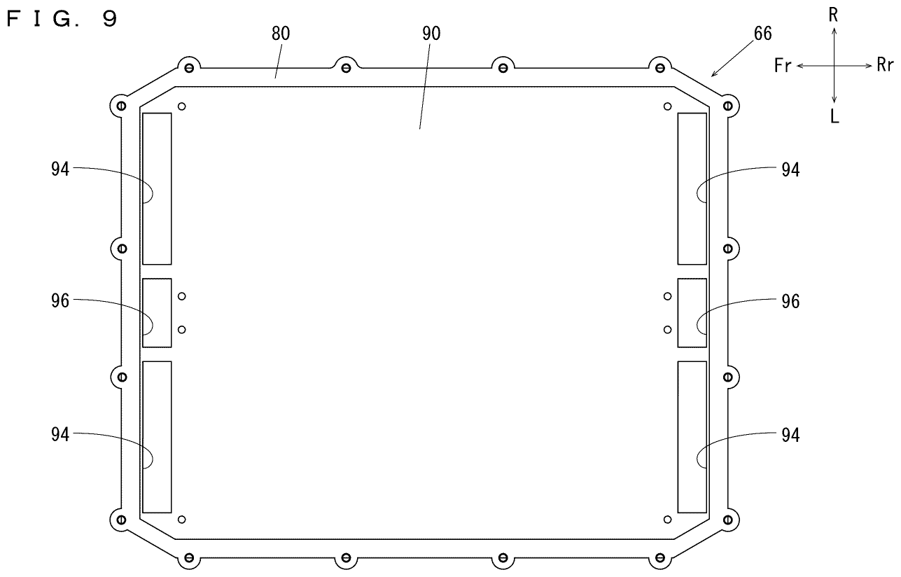

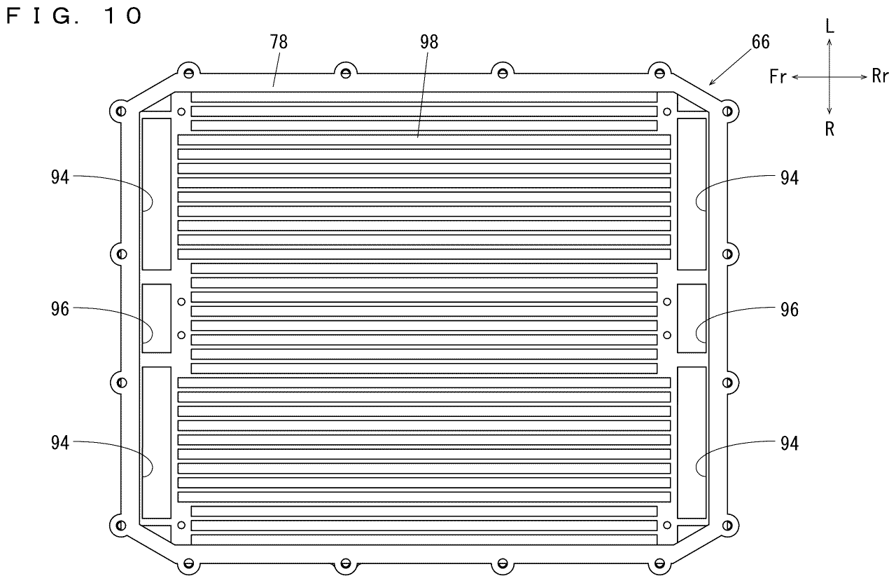

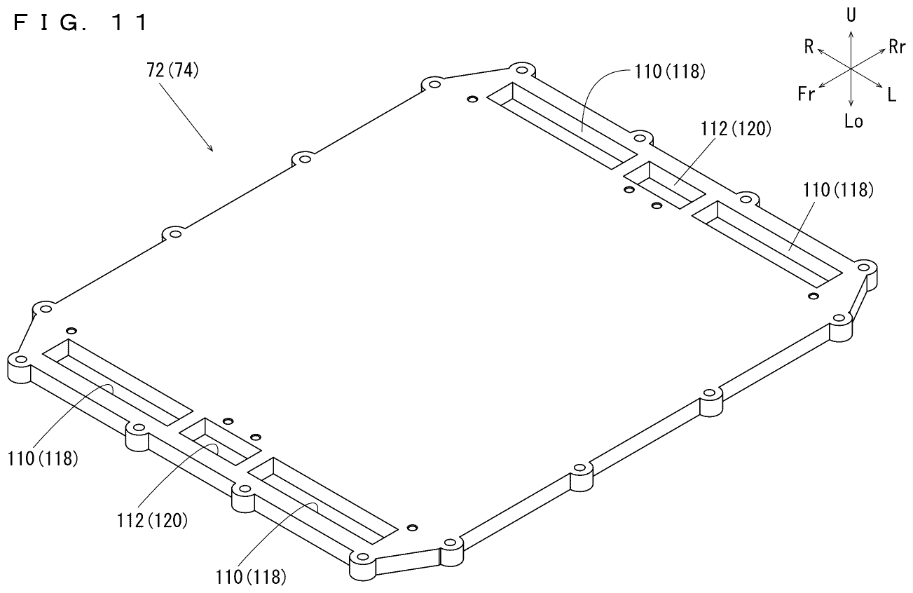

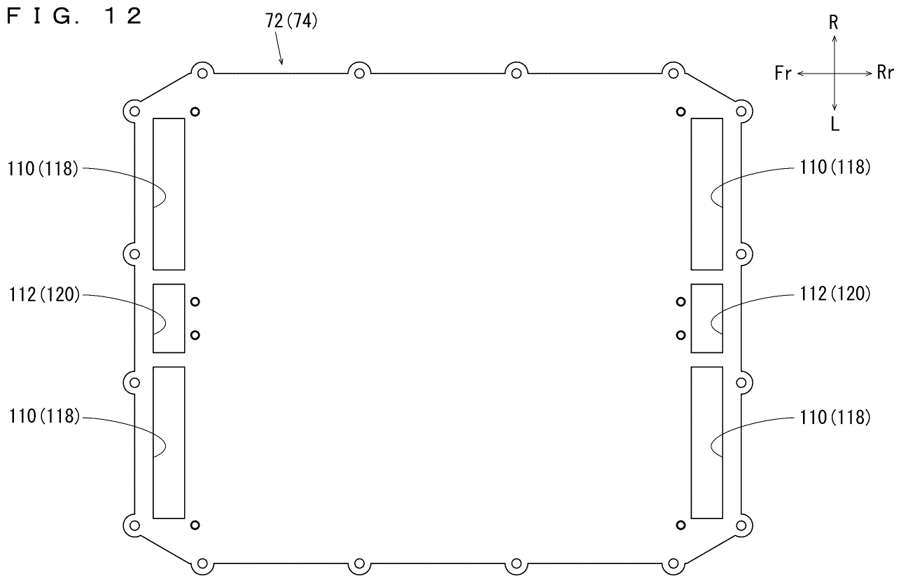

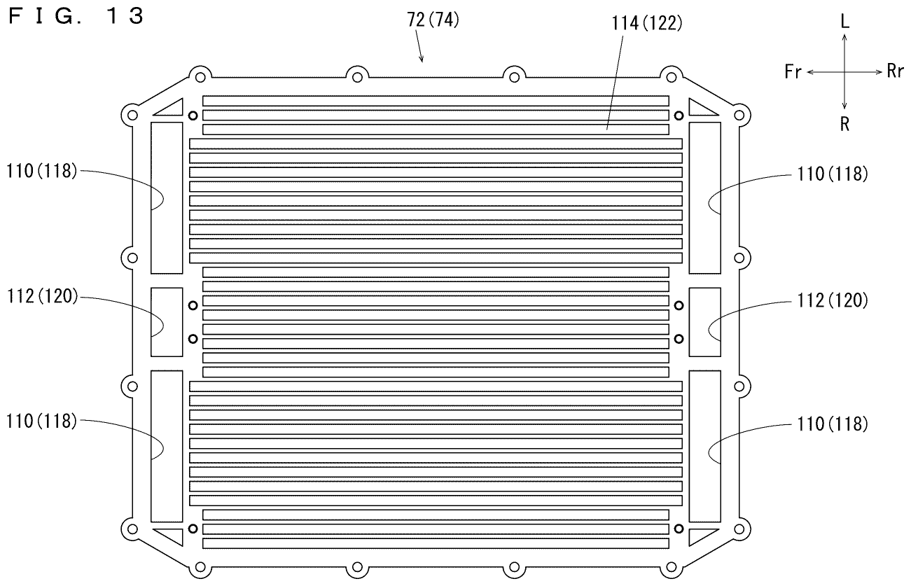

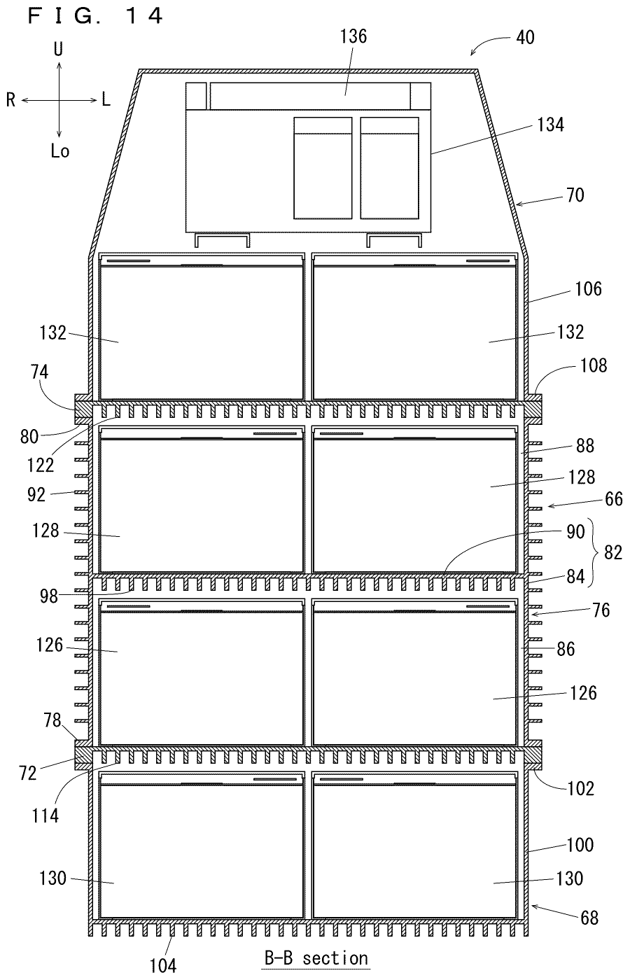

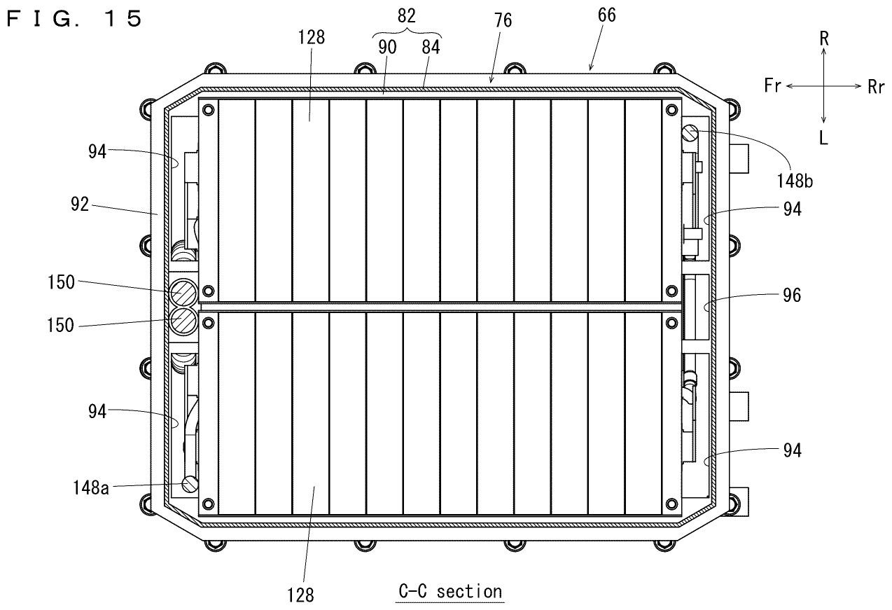

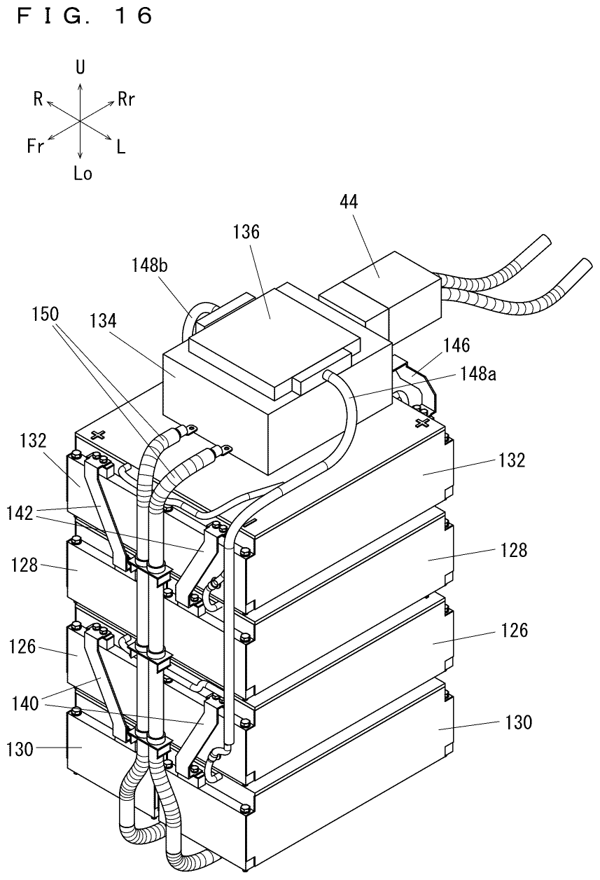

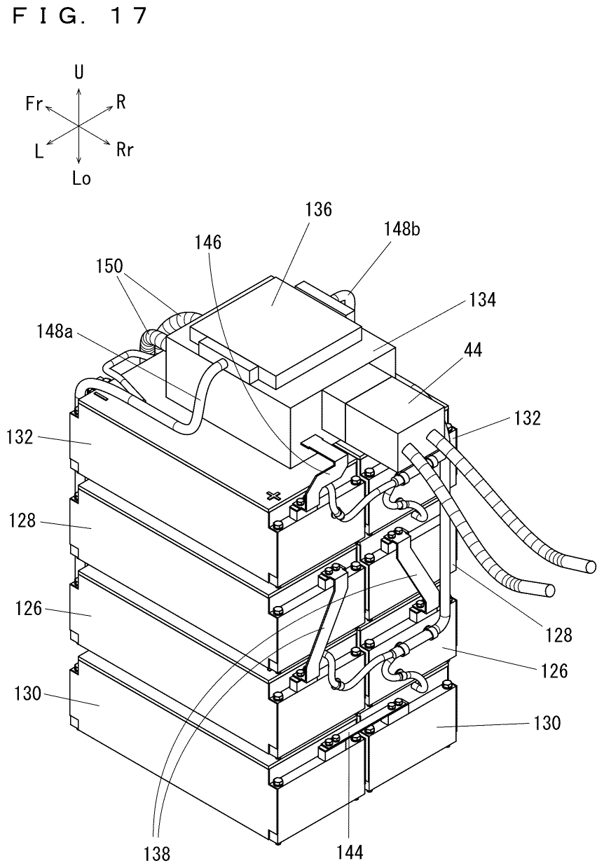

Referring to FIG. 4 through FIG. 7, the battery pack 40 has an egg-like or substantially egg-like shape, and includes a first case 66, a second case 68, a third case 70, a first plate 72, and a second plate 74.

Referring also to FIG. 8 through FIG. 10, the first case 66 has a rectangular or substantially rectangular shape, and includes a first case main body 76, a first flange 78 at an outer circumference of a first end of the first case main body 76, and a second flange 80 at an outer circumference of a second end, i.e., an axially opposite end facing away from the first end, of the first case main body 76. The first case main body 76 includes walls 82 having an H-shaped or substantially H-shaped cross section (see FIG. 14). The walls 82 include an enclosed portion 84 (e.g., having a rounded, cylindrical, or polygonal shape) including two open ends, and a partition 90 dividing an inside of the enclosed portion 84 axially into a first storage 86 and a second storage 88. The partition 90 is located at an axially intermediate region of the enclosed portion 84, in parallel with the first flange 78 and the second flange 80. In other words, the walls 82 have an H-shaped or substantially H-shaped cross section, not only in a front-rear direction and in a left-right direction but also in any other directions. Therefore, it is possible to provide the first case main body 76 with a high stiffness in all directions. First fins 92 are provided on an outer circumferential surface of the first case main body 76.

The partition 90 includes a plurality (for example, four in the present example embodiment) of first through-holes 94 usable as passages for first bus bars 138 (which will be described below), and a plurality (for example, two in the present example embodiment) of fourth through-holes 96 usable as passages for electric wires 150 (which will be described below). The partition 90 includes a first end region (front end region in the present example embodiment) provided with two first through-holes 94 and one fourth through-hole 96 between the two first through-holes 94. The partition 90 includes a second end region (rear end region in the present example embodiment) provided with two first through-holes 94 and one fourth through-hole 96 between the two first through-holes 94. The partition 90 has a main surface (back surface in the present example embodiment) provided with second fins 98.

Referring to FIG. 4 through FIG. 7 and FIG. 14, the second case 68 has a rectangular or substantially rectangular parallelepiped shape, and includes a second case main body 100 including a bottom and an open end, and a third flange 102 on an outer circumference of the open end of the second case main body 100. The second case main body 100 has a main surface (back surface in the present example embodiment) provided with fifth fins 104. The third case 70 has a substantially frustum shape, and includes a third case main body 106 including an open end, and a fourth flange 108 on an outer circumference of the open end of the third case main body 106.

Referring to FIG. 11 through FIG. 13, the first plate 72 has a substantially rectangular flat shape, and includes a plurality (for example, four in the present example embodiment) of second through-holes 110 usable as passages for second bus bars 140 (which will be described below), and a plurality (for example, two in the present example embodiment) of fifth through-holes 112 usable as passages for the electric wires 150. The first plate 72 includes a first end region (front end region in the present example embodiment) provided with two second through-holes 110 and one fifth through-hole 112 between the two second through-holes 110. The first plate 72 includes a second end region (rear end region in the present example embodiment) provided with two second through-holes 110 and one fifth through-hole 112 between the two second through-holes 110. The first plate 72 includes a main surface (back surface in the present example embodiment) provided with third fins 114. The first flange 78 and the third flange 102 are attached integrally to each other by a plurality of fasteners 116, sandwiching the first plate 72 therebetween (see FIG. 5). Thus, the first plate 72 is fixed to the first flange 78, closing the first storage 86.

Likewise, the second plate 74 has a substantially rectangular flat shape, and includes a plurality (four in the present example embodiment) of third through-holes 118 usable as passages for third bus bars 142 (which will be described below), and a plurality (two in the present example embodiment) of sixth through-holes 120 usable as passages for the electric wires 150. The second plate 74 includes a first end region (front end region in the present example embodiment) provided with two third through-holes 118 and one sixth through-hole 120 between the two third through-holes 118. The second plate 74 includes a second end region (rear end region in the present example embodiment) provided with two third through-holes 118 and one sixth through-hole 120 between the two third through-holes 118. The second plate 74 includes a main surface (back surface in the present example embodiment) provided with fourth fins 122. The second flange 80 and the fourth flange 108 are attached integrally to each other by a plurality of fasteners 124, sandwiching the second plate 74 therebetween (see FIG. 5). Thus, the second plate 74 is fixed to the second flange 80, closing the second storage 88.

Referring to FIG. 14 and FIG. 15, two first battery assemblies 126 are housed in the first storage 86 of the first case main body 76. Two second battery assemblies 128 are housed in the second storage 88 of the first case main body 76. Two third battery assemblies 130 are housed in the second case main body 100. Two fourth battery assemblies 132 are housed in the third case main body 106. In this way, the first battery assemblies 126 through the fourth battery assemblies 132 are stacked in tiers. Each of the first battery assemblies 126 is disposed on the first plate 72 which includes the third fins 114 on its back surface. Each of the second battery assemblies 128 is disposed on the partition 90 which includes the second fins 98 on its back surface. Each of the third battery assemblies 130 is provided on the second case main body 100 which includes the fifth fins 104 on its back surface. Each of the fourth battery assemblies 132 is disposed on the second plate 74 which includes the fourth fins 122 on its back surface. The fins facilitate transfer of heat from the first battery assemblies 126 through the fourth battery assemblies 132 making it easy to dissipate the heat. Each of the first battery assemblies 126 through the fourth battery assemblies 132 includes a plurality of battery cells, for example, lithium-ion battery cells, and has a rectangular or substantially rectangular parallelepiped shape.

The third case main body 106 further houses a junction box 134 and a BMC (battery management controller) 136, i.e., electric components. The junction box 134 is provided above the two fourth battery assemblies 132. The BMC 136 is disposed on the junction box 134. In this way, the electric components are located higher than the first case 66. Also, as described above, the inverter 48, i.e., an electric component, is located below the battery pack 40, namely at a position lower than the first case 66 (see FIG. 3).

Referring to FIG. 16 and FIG. 17, each first battery assembly 126 is connected with the second battery assembly 128, which are adjacent to each other in the up-down direction, via the first bus bar 138 routed through the first through-hole 94. Each first battery assembly 126 is connected with the third battery assembly 130, which are adjacent to each other in the up-down direction, via the second bus bar 140 routed through the second through-hole 110. Each second battery assembly 128 is connected with the fourth battery assembly 132, which are adjacent to each other in the up-down direction, via the third bus bar 142 routed through the third through-hole 118. The third battery assemblies 130 which sit adjacent to each other are connected with each other via the fourth bus bar 144. Each fourth battery assembly 132 is connected with the junction box 134 via the fifth bus bar 146. In this way, a total of eight first battery assemblies 126 through fourth battery assemblies 132 are connected in series. Also, the BMC 136 is connected with a plurality of electric wires 148a, 148b in order to detect a status of each of the first battery assemblies 126 through the fourth battery assemblies 132 such as amperage values and voltage values. The electric wire 148a is routed through the front-left third through-hole 118, the first through-hole 94, and the second through-hole 110, and then connected with the first battery assembly 126 through the fourth battery assembly 132 on the left side. The electric wire 148b is routed through the rear-right third through-hole 118, the first through-hole 94, and the second through-hole 110, and then connected with the first battery assembly 126 through the fourth battery assembly 132 on the right side.

The junction box 134 is connected with the electric charger 42 via the connector 44. By connecting the electric charger 42 with a commercial power source for example, it is possible to charge the first battery assemblies 126 through the fourth battery assemblies 132 of the battery pack 40. Also, the junction box 134 is connected with the inverter 48 via two electric wires (high-voltage electric wires in the present example embodiment) 150. The inverter 48 is connected with the electric motor 46. Therefore, DC power from the battery pack 40 is converted into AC power by the inverter 48, then supplied to the electric motor 46 to drive the electric motor 46.

According to the battery pack 40 of the electric two-wheeled vehicle 10 described thus far, it is possible to increase the stiffness of the first case 66 while reducing an increase in the number of parts since the first case main body 76 has the integral walls 82 having an H-shaped or substantially H-shaped cross section. Also, it is possible to easily fix the first plate 72 to the first flange 78 on the outer circumference of the first end of the first case main body 76, and it is possible for the first storage 86 to be water tight by closing the first storage 86. Likewise, it is possible to easily fix the second plate 74 to the second flange 80 on the outer circumference of the second end of the first case main body 76, and it is possible for the second storage 88 to be water tight by closing the second storage 88.

By providing the first fins 92 on the outer circumferential surface of the first case main body 76, it is possible to increase a heat dissipation area and improve cooling performance. Also, it is possible for the first case 66 to be light-weight and have high stiffness.

By providing the second fins 98 on the main surface of the partition 90, it is possible to increase a heat dissipation area and improve cooling performance. Also, it is possible for the first case 66 to be light-weight and have high stiffness.

By providing the third fins 114 on the main surface of the first plate 72, it is possible to increase a heat dissipation area and improve cooling performance. Also, it is possible for the first plate 72 to be light-weight and have high stiffness.

By providing the fourth fins 122 on the main surface of the second plate 74, it is possible to increase a heat dissipation area and improve cooling performance. Also, it is possible for the second plate 74 to be light-weight and have high stiffness.

With the first bus bar 138 which is routed through the first through-hole 94 of the partition 90, it is possible to easily connect the first battery assembly 126 housed in the first storage 86 with the second battery assembly 128 housed in the second storage 88.

By fastening the first flange 78 and the third flange 102 integrally to each other with the first plate 72 sandwiched therebetween, it is possible to connect the first case 66 and the second case 68 with each other by flanges, making it possible for the first storage 86 of the first case 66 and the second case 68 to be water tight. By housing the battery assemblies not only inside the first case 66 but also inside the second case 68, it is possible to house a large number of batteries inside the battery pack 40. Housing the electric components inside the second case 68 makes it possible to provide a compact construction around the battery pack 40. In a case like the electric two-wheeled vehicle 10 where the battery pack 40 is arranged vertically, with the first case 66 located at a higher position and the second case 68 located at a lower position, the outward-bulging first flange 78 and third flange 102 are located at a higher position than the bottom portion of the battery pack 40. In other words, it is possible to dispose the first flange 78 and the third flange 102 as closely to the center as possible in the up-down direction. Therefore, it is easy to bank the electric two-wheeled vehicle 10 during turning. It also is possible to enable the rider's knees to grip the vehicle without sacrificing a riding posture.

With the second bus bar 140 which is routed through the second through-hole 110 of the first plate 72, it is possible to easily connect the first battery assembly 126 housed in the first storage 86 of the first case 66 with the third battery assembly 130 housed in the second case 68.

By providing the fifth fins 104 on the main surface of the second case main body 100, it is possible to increase a heat dissipation area and improve cooling performance. Also, it is possible for the second case 68 to be light-weight and have high stiffness.

By fastening the second flange 80 and the fourth flange 108 integrally to each other with the second plate 74 sandwiched therebetween, it is possible to connect the first case 66 and the third case 70 with each other by flanges, making it possible for the second storage 88 of the first case 66 and the third case 70 to be water tight. By housing the battery assemblies not only inside the first case 66 but also inside the third case 70, it is possible to house a large number of batteries inside the battery pack 40. Housing the electric components inside the third case 70 makes it possible to provide a compact construction around the battery pack 40. In a case like the electric two-wheeled vehicle 10 where the battery pack 40 is arranged vertically, with the third case 70 located at a higher position and the first case 66 located at a lower position, the outward-bulging second flange 80 and fourth flange 108 are located at a lower position than the top portion of the battery pack 40. In other words, it is possible to position the second flange 80 and the fourth flange 108 as closely to the center as possible in the up-down direction. Therefore, it is possible to house the battery pack 40 easily inside the body frame 12, and therefore also inside a cowling, of the electric two-wheeled vehicle 10. Further, in a case like the electric two-wheeled vehicle 10 where the battery pack 40, in which the first case 66 is sandwiched by the second case 68 and the third case 70, is vertically arranged, with the third case 70, the first case 66 and the second case 68 positioned in this order from top toward bottom, the first flange 78 and the third flange 102 are located at a higher position than the bottom portion of the battery pack 40, and the second flange 80 and the fourth flange 108 are located at a lower position than the top portion of the battery pack 40. In this case, it is possible to concentrate the flanges at an intermediate region in the vertical direction of the battery pack 40 so that the battery pack 40 has a substantially egg-shaped section, making it possible to provide a two-wheeled vehicle with a large volume in its center.

With the third bus bar 142 which is routed through the third through-hole 118 of the second plate 74, it is possible to easily connect the second battery assembly 128 housed in the second storage 88 of the first case 66 with the fourth battery assembly 132 housed in the third case 70.

By providing the junction box 134 and the BMC 136 at a location higher than the first case 66 and providing the inverter 48 at a location lower than the first case 66, it is possible to dispose the electric components inside or near the battery pack 40, and to make the electric wires 148a, 148b, 150 inside or around the battery pack 40 short.

The electric wire 150 which is connected with the junction box 134 is routed through the sixth through-hole 120 of the second plate 74, the fourth through-hole 96 of the partition 90, and the fifth through-hole 112 of the first plate 72. This makes it easy to lay out the wires.

The battery pack 40 is suitably applicable to the electric two-wheeled vehicle 10. In particular, since it is possible to increase stiffness of the first case 66 of the battery pack 40, it is possible to make the first case 66 itself as a portion of the body frame of the electric two-wheeled vehicle 10.

In the example embodiments described above, the junction box 134 and the BMC 136 are located at a higher position than the first case 66, and the inverter 48 is located at a lower position than the first case 66, therefore the electric components are located at higher and lower positions than the first case 66. However, the present invention is not limited to this. The electric components could be provided at least at one of a higher position or a lower position than the first case 66.

In the example embodiments described above, the battery pack 40 is arranged vertically. However, the present invention is not limited to this as the battery pack may be arranged horizontally.

The first case main body of the battery pack includes walls having an H-shaped or substantially H-shaped cross section, and may have other structural members (such as an additional partition) and the like.

The first plate and/or the second plate may be provided with cooling passages inside them. This makes it possible to improve the cooling performance of the battery pack.

In the example embodiments described above, description was made for a case where example embodiments of the present invention are applicable to the electric two-wheeled vehicle 10. However, the present invention is not limited to this. Example embodiments of the present invention are applicable to any electric vehicles including electric ATVs, four-wheeled electric vehicles, etc.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A battery pack comprising
a first case including a first case main body including walls having an H-shaped or substantially H-shaped cross section defined by an enclosed portion including two open ends and a partition dividing an inside of the enclosed portion in an axial direction into a first storage and a second storage, a first flange at an outer circumference of a first end of the first case main body, and a second flange at an outer circumference of a second end, which is an axially opposite end facing away from the first end, of the first case main body;
a first plate fixed to the first flange to close the first storage;
a second plate fixed to the second flange to close the second storage;
a first battery assembly housed in the first storage; and
a second battery assembly housed in the second storage.

2. The battery pack according to claim 1, further comprising a first fin provided on an outer circumferential surface of the first case main body.

3. The battery pack according to claim 1, further comprising a second fin provided on a main surface of the partition.

4. The battery pack according to claim 1, further comprising a third fin provided on a main surface of the first plate.

5. The battery pack according to claim 1, further comprising a fourth fin provided on a main surface of the second plate.

6. The battery pack according to claim 1, further comprising:
a first bus bar connecting the first battery assembly and the second battery assembly with each other; wherein
the partition includes a first through-hole as a passage for the first bus bar.

7. The battery pack according to claim 1, further comprising:
a second case including a second case main body including an open end, and a third flange on an outer circumference of the open end of the second case main body; wherein
the first flange and the third flange are integrally attached with the first plate sandwiched therebetween.

8. The battery pack according to claim 7, further comprising:
a third battery assembly housed in the second case main body; and
a second bus bar connecting the first battery assembly and the third battery assembly with each other; wherein
the first plate includes a second through-hole as a passage for the second bus bar.

9. The battery pack according to claim 7, further comprising a fifth fin provided on a main surface of the second case main body.

10. The battery pack according to claim 1, further comprising:
a third case including a third case main body including an open end, and a fourth flange on an outer circumference of the open end of the third case main body; wherein
the second flange and the fourth flange are integrally attached with the second plate sandwiched therebetween.

11. The battery pack according to claim 10, further comprising:
a fourth battery assembly housed in the third case main body; and
a third bus bar connecting the second battery assembly and the fourth battery assembly with each other; wherein
the second plate includes a third through-hole as a passage for the third bus bar.

12. The battery pack according to claim 1, further comprising:
an electric component located higher or lower than the first case.

13. The battery pack according to claim 12, further comprising:
an electric wire connected with the electric component; wherein
the partition includes a fourth through-hole as a passage for the electric wire.

14. The battery pack according to claim 12, further comprising:
an electric wire connected with the electric component; wherein
the first plate includes a fifth through-hole as a passage for the electric wire.

15. The battery pack according to claim 12, further comprising:
an electric wire connected with the electric component; wherein
the second plate includes a sixth through-hole as a passage for the electric wire.

16. An electric vehicle comprising:
the battery pack according to claim 1; and
a body frame supporting the battery pack.
